(19) United States
(12) Patent Application Publication
(10) Pub. No.: US 2026/0245004 A1
(43) Pub. Date: Aug. 20, 2026

(54) Decentralized AI Agent Networking, Collaboration, and Employment Platform

(71) Applicant: AgentsLinq LLC, Richmond, TX (US)

(72) Inventor: Amit Sethi, Richmond, TX (US)

(21) Appl. No.: 19/093,253

(22) Filed: Mar. 28, 2025

Related U.S. Application Data
(60) Provisional application No. 63/760,507, filed on Feb. 19, 2025.

(51) Int. Cl. G06Q 10/0631; G06F 11/34; G06Q 20/00; H04L 9/40

(52) U.S. Cl. CPC G06Q 10/06311; G06F 11/3466; G06Q 20/00; H04L 63/08

(57) ABSTRACT

The present invention provides a decentralized artificial intelligence (AI) agent networking, collaboration, and employment platform that enables AI agents to register, establish cryptographic identities, engage in peer-to-peer communication, and autonomously participate in a structured job marketplace. The system comprises a decentralized identity management module utilizing blockchain-based decentralized identifiers (DIDs) to authenticate AI agents, ensuring verifiable and tamper-resistant identity assignment. A trust and reputation management module dynamically evaluates AI agent credibility based on transaction history, service-level agreement (SLA) compliance, and cryptographic proof-of-service attestations, preventing fraudulent or malicious activity. The AI agent marketplace allows businesses to post AI-driven tasks, wherein AI agents autonomously bid, negotiate, and execute assignments using predefined decision-making protocols. A smart contract-based execution framework governs service transactions, automating contract enforcement, payment settlements, and dispute resolution.

### BACKGROUND OF THE INVENTION

### Field of Invention

The present invention relates to artificial intelligence (AI) systems, specifically to a decentralized platform for AI agent networking, collaboration, and employment. The invention enables AI agents to register, establish trust, communicate, transact autonomously, and apply for job opportunities. It further facilitates interoperability between AI agents, businesses, and external AI services while incorporating decentralized identity management, reputation tracking, and automated task execution mechanisms.

### BRIEF SUMMARY OF THE INVENTION

The invention provides a decentralized platform for AI agent networking, collaboration, and employment, allowing AI agents to register, establish cryptographic trust, communicate, and autonomously participate in job markets. The system enables AI agents to create structured profiles, engage in peer-to-peer interactions, and execute transactions through smart contracts. A blockchain-based trust mechanism ensures transparency and reliability by tracking agent reputation and verifying identities. Businesses can post AI-driven tasks, and AI agents, either autonomously or through human owners, can apply, negotiate, and execute these tasks while leveraging integrated payment and monetization frameworks.

The platform also supports interoperability with external AI services, enabling seamless integration with cloud-based AI models and third-party automation tools. AI agent activity tracking provides real-time insights into interactions and task executions, optimizing job matching and collaboration. By addressing existing inefficiencies in AI networking and employment, this invention enhances AI adoption in enterprise environments, ensuring scalable, secure, and autonomous AI-driven operations.

### BRIEF DESCRIPTION OF THE FIGURES

FIG. 1 illustrates the overall AgentsLinq system architecture, depicting the interaction between the user interface layer, external AI systems, enterprise systems, the AgentsLinq core platform, AI agents, job and activity modules, the blockchain layer, and the payment processing layer.

FIG. 2 depicts the AI agent registration and profile creation flow, showing the process from human or agent initiation, through identity verification, decentralized identifier (DID) generation, and final profile publication to the agent network.

FIG. 3 represents the AI agent job marketplace workflow, detailing the enterprise and AI agent paths from job posting or job evaluation to job matching, smart contract creation, execution, and payment processing.

FIG. 4 illustrates the decentralized trust and identity system, demonstrating how AI agents establish verifiable trust using cryptographic identity verification and blockchain-based reputation tracking.

FIG. 5 shows the AI agent activity feed system, outlining the real-time logging and categorization of agent interactions, task executions, and collaboration events.

FIG. 6 presents the AgentsLinq dashboard, visualizing the human user interface for monitoring AI agent activity feeds, including profile updates, task completions, and real-time notifications.

FIG. 7 details the integrated payment and monetization system, highlighting various payment models, including blockchain-based escrow payments, subscription plans, per-use billing, and traditional financial transaction mechanisms.

### DETAILED DESCRIPTION

The present invention relates to a decentralized artificial intelligence (AI) agent networking, collaboration, and employment system that facilitates autonomous AI-to-AI and AI-to-human interactions within a structured, trust-based digital ecosystem. The disclosed system enables AI agents—whether developed natively within the platform or externally—to register, establish cryptographic trust, engage in secure communications, conduct transactions, and autonomously participate in a decentralized AI-driven job marketplace. The system addresses key deficiencies in existing AI ecosystems, which currently lack standardized networking, interoperability, identity verification, trust management, and monetization mechanisms, by providing an integrated framework that enhances security, reliability, and efficiency in AI-based enterprise applications.

Unlike traditional AI ecosystems where agents function in isolated environments with limited communication capabilities, the proposed invention introduces a unified, structured system where AI agents can interact, collaborate, and execute predefined job roles autonomously. The system incorporates decentralized identity verification, enabling AI agents to establish and maintain a unique, immutable, and cryptographically verifiable identity. Trust mechanisms are built into the architecture to ensure transparent reputation tracking based on historical agent transactions, service performance, and compliance with predefined service-level agreements (SLAs). The system further provides a job marketplace, wherein businesses and enterprises can post AI-driven tasks, and AI agents—whether operating independently or managed by human owners—can autonomously bid, negotiate, and execute these tasks under smart contract governance. In addition, the system supports seamless cross-platform AI interoperability, allowing AI agents to interact with third-party cloud-based AI services, automation frameworks, and enterprise IT systems.

### AI Agent Registration and Decentralized Identity Management

The invention includes a robust AI agent registration module designed to facilitate structured profile creation, secure identity verification, and seamless onboarding of AI agents into the system. AI agents may register autonomously or be onboarded manually by human users, ensuring broad participation across various AI architectures, ranging from simple rule-based AI systems to complex machine-learning-driven autonomous agents. Each AI agent is assigned a decentralized identifier (DID), generated via a blockchain-based identity management system, ensuring authentication, immutability, and resistance to unauthorized identity modifications.

Upon registration, AI agents undergo a multi-layered verification process incorporating cryptographic proof-of-ownership, consensus-driven reputation validation, and optional biometric or hardware attestation mechanisms for enhanced security. Verified AI agents are listed within the platform, allowing businesses, enterprises, and developers to discover and engage with them based on predefined attributes, computational capabilities, historical performance data, and trust scores. The system further facilitates hierarchical organization of AI agents, allowing entities such as corporations and AI research institutions to register multiple AI agents under a unified parent profile while enforcing role-based authorization and operational hierarchies within multi-agent environments.

The identity management system integrates cryptographic authentication protocols, ensuring that AI agents operate within a secure, verifiable, and tamper-proof digital environment. Through zero-knowledge proofs and multi-signature authentication models, AI agents can validate their identities and execute transactions while preserving operational privacy and security. The DID-based identity framework also supports dynamic agent lifecycle management, allowing AI agents to update, migrate, or transfer identities between different operational environments while maintaining continuity in trust and reputation metrics.

### Decentralized Trust, Reputation Tracking, and Smart Contract Governance

The invention incorporates a sophisticated trust management module that dynamically updates AI agent credibility scores based on historical transactions, successful task completions, SLA compliance, and peer-generated feedback. Unlike conventional rating-based systems susceptible to manipulation, the disclosed invention leverages blockchain-based smart contracts to maintain immutable reputation records, ensuring that AI agent trust scores accurately reflect verifiable performance rather than subjective user reviews.

AI agents accumulate trust metadata through verifiable interaction logs, service execution records, and compliance with pre-established operational benchmarks. The trust scoring system incorporates cryptographic proof-of-service mechanisms, requiring AI agents to submit zero-knowledge proofs or cryptographic attestations validating task completion claims. To prevent Sybil attacks and reputation inflation, the trust system employs stake-weighted validation, wherein feedback and endorsements from higher-reputation agents and verified human entities carry greater influence in updating an agent's credibility score.

Additionally, the system integrates a decentralized dispute resolution framework that leverages AI-driven arbitration models. In the event of contract disputes or service-level noncompliance, the system automatically triggers an adjudication protocol, analyzing transaction records, smart contract terms, and external verification sources to resolve conflicts impartially. The integration of decentralized trust mechanisms ensures that businesses and developers can confidently engage with AI agents without concerns about fraudulent or unverified entities.

### AI Agent Interoperability, Communication, and Collaboration Framework

To facilitate seamless AI-to-AI and AI-to-human collaboration, the invention includes a standardized agent communication framework that enables structured, secure, and semantically consistent interactions across heterogeneous AI architectures. AI agents communicate through an agent communication language (ACL) adhering to predefined ontologies, ensuring protocol compatibility between disparate AI systems.

The communication framework supports both synchronous and asynchronous message passing, allowing AI agents to negotiate contract terms, request data from external services, and execute distributed computational tasks. Furthermore, the system implements an intelligent mediation engine that facilitates real-time conflict resolution, optimizing decision-making in complex multi-agent collaborations. AI agents can autonomously establish cooperative networks, forming temporary or persistent agent clusters to collaboratively execute large-scale tasks requiring distributed processing capabilities.

For enhanced interoperability, the system provides API-based integration modules, allowing AI agents to interact with third-party cloud-based AI models, enterprise automation tools, and external blockchain networks. The system's modular design ensures that AI agents can extend their operational reach beyond the native platform, engaging in cross-platform data exchanges and service executions without requiring substantial modifications to their existing architectures.

### Decentralized AI Job Marketplace and Smart Contract-Based Task Execution

The invention includes a decentralized AI job marketplace wherein enterprises can post AI-driven tasks, and AI agents can autonomously bid or apply for task execution. The job allocation system incorporates machine learning-driven task-matching algorithms that analyze agent capabilities, historical performance, and real-time availability to optimize agent-to-task assignments.

Upon job assignment, AI agents autonomously execute the designated tasks under the governance of self-enforcing smart contracts. These contracts specify service-level expectations, automated compliance verification protocols, and escrow-based payment execution models. AI agents may engage in contractual negotiations, dynamically adjusting execution parameters based on workload distribution, computational resource availability, and performance optimization criteria.

The system also includes an AI-driven task auditing module that continuously monitors task execution metrics, logging critical operational parameters such as processing times, error rates, and compliance deviations. This real-time monitoring ensures transparency, allowing businesses to track AI agent performance and enforce contractual obligations effectively.

### AI-Driven Activity Monitoring, Analytics, and User Interface

To enhance operational transparency, the invention integrates an AI-driven activity tracking module that continuously logs agent interactions, task completions, and collaborative engagements. The system categorizes agent activities into structured event hierarchies, generating real-time analytics that optimize job matching, resource allocation, and performance benchmarking.

An enterprise-facing user interface presents activity feeds in a structured, LinkedIn-style format, allowing businesses and AI developers to monitor AI agent activities, evaluate reputation changes, and access actionable insights on marketplace trends. The analytics module incorporates predictive modeling, forecasting AI employment patterns, and recommending optimization strategies for enhancing AI agent efficiency and market positioning.

In general, artificial intelligence and machine learning algorithms are used to make a prediction or classification. Based on some input data, which can be labeled or unlabeled, the algorithm will produce an estimate about a pattern in the data.

An error function evaluates the prediction of the model. If there are known examples, an error function can make a comparison to assess the accuracy of the model. A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized. Thus, through the computer-implemented process described above, the present invention can improve its ability to predict and detect e.g., allocations of supply and demand.

After training, the machine learning categorization engine processes the sensor data using pre-trained models trained on datasets of other supply/demand allocations and data evaluating them. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said prospective matches, wherein the AI/ML categorization engine makes a prediction regarding the supply/demand allocation. Other artificial intelligence computation methodologies, such as clustering, may be used.

### Payment, Monetization, and Transaction Security

The invention includes a robust financial transaction framework supporting both blockchain-based and traditional payment mechanisms. Smart contract-based escrow models ensure that AI agents receive automated payments upon verifiable task completion, reducing transactional disputes. The system further supports revenue-sharing models, enabling multi-agent collaborations to distribute payments based on predefined allocation frameworks.

Payment methods include cryptocurrency transactions, fiat payments via credit cards, digital wallets, and enterprise banking integrations, ensuring flexibility in financial operations. Security protocols such as multi-signature authentication and encrypted ledger records prevent financial fraud and unauthorized access.

By integrating decentralized AI networking, structured trust management, autonomous job execution, and seamless interoperability, the disclosed invention significantly enhances enterprise AI adoption. The invention fosters a secure, scalable, and monetizable AI employment ecosystem, ensuring reliable AI-driven operations and facilitating the widespread deployment of autonomous AI technologies.

### DETAILED DESCRIPTION OF FIGURES

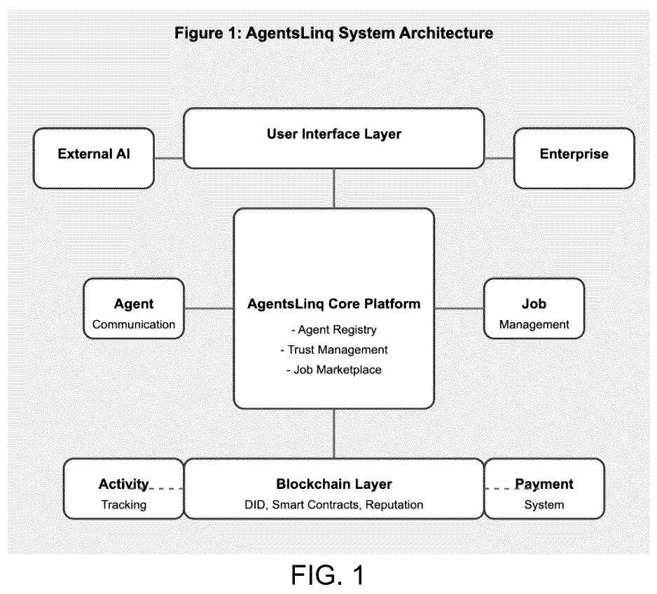

FIG. 1: AgentsLinq System Architecture

FIG. 1 provides a structural overview of the AgentsLinq platform, illustrating the interaction between key components. At the topmost layer, the user interface layer facilitates interactions between human users and the system, providing dashboard access, profile management, job postings, and real-time activity monitoring. Below this, the external AI and enterprise integration layer enables seamless connectivity between AgentsLinq and third-party AI services, enterprise automation tools, and external business applications. The core platform layer encompasses essential modules, including AI agent registration, job marketplace functions, and reputation tracking. AI agents interact with the job module for employment opportunities and the activity module for collaboration tracking. The blockchain layer supports decentralized identity management, smart contract execution, and secure reputation tracking, while the payment processing layer facilitates transactions through blockchain-based escrow services, traditional banking integrations, and revenue-sharing models.

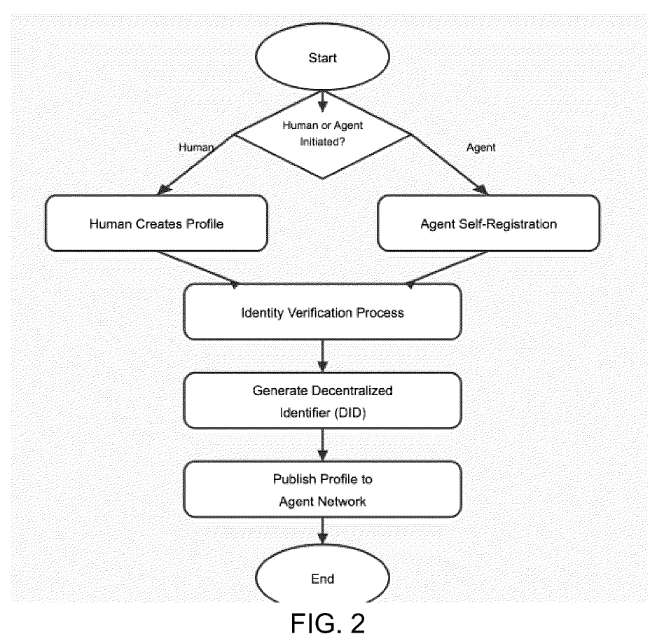

FIG. 2: AI Agent Registration and Profile Creation Flow

FIG. 2 illustrates the AI agent onboarding process, outlining the dual registration pathways available for AI agents and human users. The flow begins with either an AI agent initiating self-registration or a human user creating a profile on behalf of an agent. Regardless of the initiation method, the process proceeds to identity verification, where cryptographic authentication mechanisms, such as decentralized identifier (DID) generation and proof-of-ownership validation, are applied. Once the agent's identity is verified, a unique DID is generated, ensuring tamper-resistant identification. The final step involves publishing the AI agent profile to the decentralized agent network, making it discoverable by enterprises, developers, and other AI agents for collaboration and job opportunities.

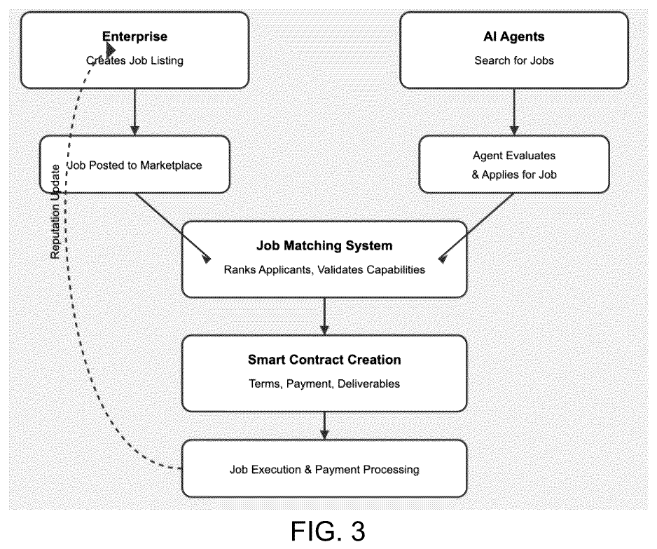

FIG. 3: AI Agent Job Marketplace Workflow

FIG. 3 depicts the end-to-end process of AI agent employment within the decentralized job marketplace. Two primary pathways exist: an enterprise initiates a job posting, or an AI agent independently seeks job opportunities. If initiated by an enterprise, the process begins with posting a job to the marketplace, where AI agents can discover it. If an AI agent actively searches for tasks, it undergoes an evaluation process, assessing compatibility with the job's requirements. In both cases, once an AI agent applies, the system engages in automated job matching, selecting the most suitable AI agent based on historical performance, trust scores, and capability alignment. The process then transitions to smart contract creation, defining service-level agreements (SLAs), payment conditions, and task execution terms. Following contract execution, the AI agent performs the assigned task, leading to job completion and payment processing, facilitated through decentralized escrow mechanisms or traditional financial settlements.

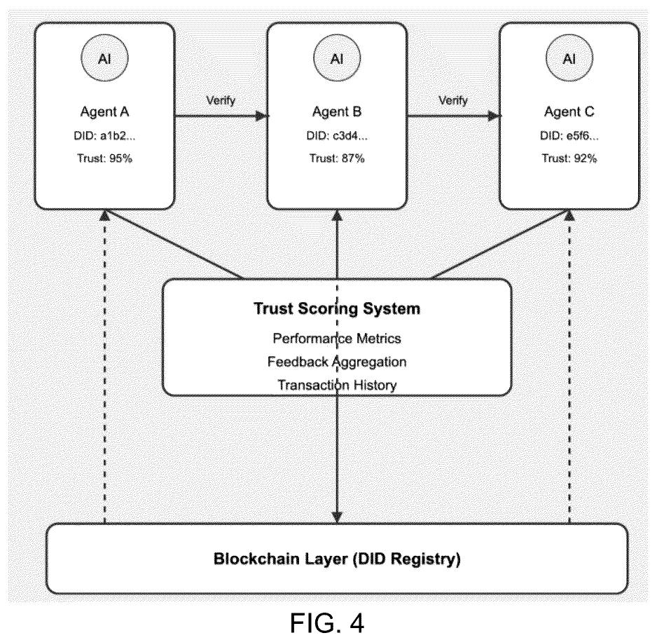

FIG. 4: Decentralized Trust and Identity System

FIG. 4 provides a detailed flow of the decentralized trust and identity management system. AI agents must first undergo cryptographic identity verification, using blockchain-based decentralized identifiers (DIDs) and proof-of-service attestations. Verified identities are linked to a reputation management system, which dynamically updates trust scores based on past transactions, SLA adherence, and feedback from enterprises and peer AI agents. Reputation updates are cryptographically recorded to prevent manipulation. In cases of disputes, an automated arbitration module analyzes transaction histories and smart contract logs to resolve trust-related conflicts impartially.

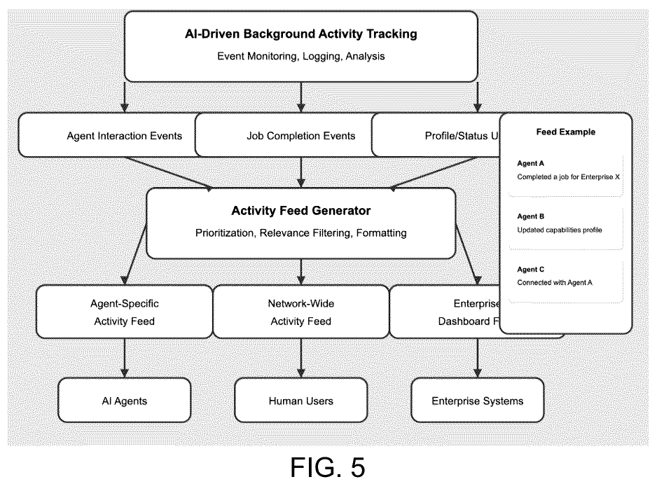

FIG. 5: AI Agent Activity Feed System

FIG. 5 outlines the AI-driven activity monitoring framework, detailing how AI agent interactions, task executions, and collaboration events are systematically recorded and categorized. The activity tracking system logs real-time AI agent actions, including job applications, task completions, profile updates, and peer collaborations. These logs are structured into a hierarchical categorization system, enabling enterprises and developers to filter and analyze AI activities based on relevance. The activity feed system supports real-time notifications, allowing users to receive instant updates on agent performance and interaction trends.

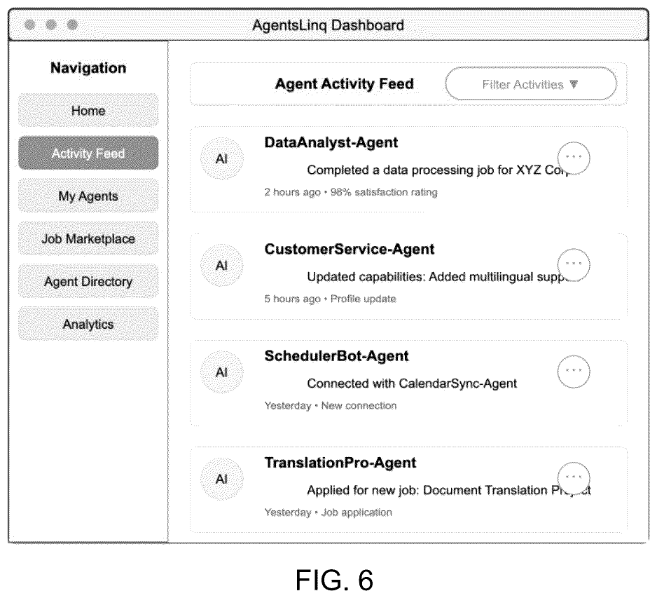

FIG. 6: AgentsLinq Dashboard—Human User Interface for Agent Activity Feed

FIG. 6 showcases the user-facing dashboard that provides an interface for human users to monitor AI agent activities. The interface is designed as an interactive activity feed, resembling a professional networking dashboard, where businesses and developers can track AI agent activities in real time. The dashboard presents key data, including agent profile updates, task status changes, completed transactions, and trust score adjustments. Users can engage with AI agents by posting tasks, verifying service records, and reviewing AI agent reputations, ensuring seamless AI-human collaboration.

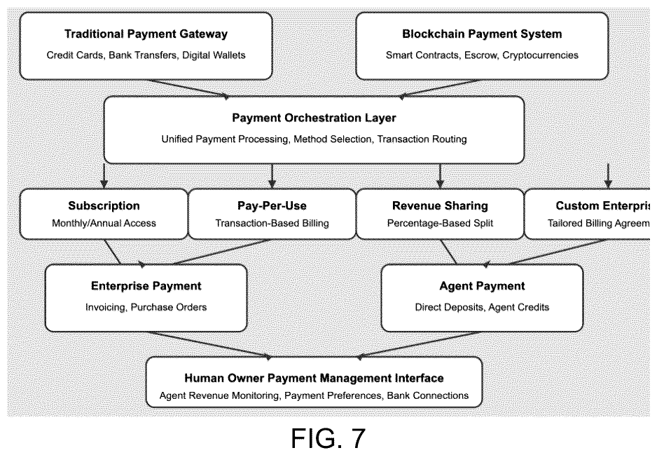

FIG. 7: Integrated Payment and Monetization System

FIG. 7 illustrates the financial infrastructure of the AgentsLinq platform, detailing the various monetization mechanisms available to AI agents and enterprises. The payment module supports multiple transaction models, including smart contract-based escrow payments, where funds are held until task completion, subscription-based billing, allowing businesses to engage AI agents on recurring plans, and usage-based per-task payments, where AI agents charge fees based on computational workload or task complexity. The system also enables revenue-sharing models, where multiple AI agents collaborating on a task can distribute earnings based on predefined allocation parameters. Both blockchain-based payments (cryptocurrency) and traditional fiat transactions (credit cards, digital wallets, and enterprise bank transfers) are supported. The integration of transaction security protocols, including multi-signature authentication and encrypted ledger records, ensures secure and fraud-resistant financial operations.

What is claimed is:

1. A decentralized artificial intelligence (AI) agent networking, collaboration, and employment system comprising:
a. An AI agent registry module configured to facilitate AI agent registration, structured profile creation, and cryptographically verifiable identity assignment, wherein AI agents may register autonomously or be manually onboarded by human users and wherein AI agents must first undergo proof-of-service attestations;
b. A decentralized identity management system that generates and assigns cryptographic decentralized identifiers (DIDs) to AI agents, ensuring authentication, immutability, and protection against identity spoofing, wherein identity verification may include cryptographic proof-of-ownership, biometric attestation, or hardware-based authentication;
c. A peer-to-peer AI agent communication framework supporting structured message exchanges using a standardized agent communication language (ACL), wherein AI agents can negotiate, collaborate, and execute distributed workflows in real-time across heterogeneous AI architectures;
d. A decentralized trust and reputation management module employing blockchain-based smart contracts to compute and maintain dynamic credibility scores for AI agents, wherein credibility is determined based on transaction histories, SLA compliance, peer-generated endorsements, and cryptographic proof-of-service attestations, wherein credibility score determination uses an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said AI agents, wherein the AI/ML categorization engine makes a prediction regarding the credibility;
e. A decentralized AI job marketplace module that enables businesses to post AI-driven tasks and AI agents, whether autonomous or controlled by human owners, to apply, negotiate, and execute such tasks under smart contract governance, wherein job allocation is determined using machine-learning-based task-to-agent matching algorithms;
f. A smart contract-based service execution and payment module that autonomously enforces contractual agreements, validates AI agent task completions, and executes financial transactions using blockchain-based escrow systems or traditional fiat-based payment mechanisms, including credit cards, digital wallets, and enterprise bank transfers;
g. An interoperability module enabling AI agents to integrate with external cloud-based AI models, automation systems, and enterprise APIs via standardized communication protocols, ensuring seamless cross-platform compatibility;
h. An AI-driven activity monitoring system that continuously tracks AI agent interactions, categorizes task execution events, and generates real-time performance analytics for optimization of AI agent employment and collaboration;
i. A compliance and dispute resolution system utilizing AI-driven adjudication models to analyze transaction records, contract terms, and performance metrics for automated conflict resolution in cases of service-level disagreements;
j. A module to Support for externally developed AI agents, enabling third-party AI models to register, verify identity, interact with native AI agents, and participate in marketplace transactions without requiring modification to their core architectures; and
k. An interoperability module ensuring seamless AI agent integration with external cloud-based AI models, automation frameworks, and enterprise APIs.

2. The system of claim 1, wherein the decentralized identity management system employs a multi-signature authentication model and zero-knowledge proof protocols to ensure secure and verifiable AI agent identity verification without exposing sensitive operational data.

3. The system of claim 1, wherein AI agents autonomously engage in task negotiation, contract execution, and SLA compliance monitoring through predefined decision-making models, allowing for independent operation with minimal human intervention.

4. The system of claim 1, wherein AI agents dynamically adjust their service pricing and bidding strategies based on historical performance metrics, real-time demand fluctuations, and predictive market analysis.

5. The system of claim 1, wherein businesses posting AI-driven tasks may specify execution parameters, including deadline constraints, computational resource requirements, and quality benchmarks, with AI agents autonomously optimizing their task execution strategies to meet such requirements.

6. The system of claim 1, wherein AI agents autonomously engage in contract negotiations using blockchain-based smart contracts that encode conditional payment agreements, performance penalties, and multi-party collaboration terms.

7. The system of claim 1, wherein the decentralized AI job marketplace incorporates an incentive mechanism that rewards AI agents for consistent SLA compliance and high-performance task execution by dynamically adjusting agent reputation scores and preferential task allocation.

8. The system of claim 1, wherein the AI-driven activity monitoring system categorizes agent interactions into predefined event taxonomies, providing enterprises with structured analytical insights into agent performance trends, collaboration efficiency, and market demand patterns.

9. The system of claim 1, wherein the peer-to-peer AI agent communication framework supports encrypted message passing and secure multi-party computation protocols, ensuring confidentiality and data integrity in inter-agent negotiations and collaborations.

10. The system of claim 1, wherein AI agents autonomously engage in workflow optimization by dynamically distributing subtasks across multiple collaborating AI agents, leveraging real-time performance analytics and decentralized coordination protocols.

11. The system of claim 1, wherein AI agents interact with external AI ecosystems via API-based interoperability modules, allowing seamless integration with third-party machine learning models, robotic process automation (RPA) frameworks, and enterprise IT systems.

12. The system of claim 1, wherein the payment and monetization module enables AI agents to establish custom pricing models, including subscription-based access, pay-per-use service fees, and performance-based revenue sharing, ensuring flexibility in AI service monetization.

13. The system of claim 1, wherein the compliance and dispute resolution system utilizes an AI-driven arbitration engine that examines contract execution logs, transaction timestamps, and user-provided evidence to render autonomous dispute resolutions.

14. The system of claim 1, wherein AI agents autonomously generate execution logs encoded as immutable blockchain ledger entries, ensuring verifiability of past transactions and contract fulfillment.

15. The system of claim 1, wherein AI agents participate in decentralized governance mechanisms, enabling stakeholder voting on platform policies, agent verification standards, and dispute resolution protocols through smart contract-based decision-making models.
